(19) United States
(12) Patent Application Publication
(10) Pub. No.: US 2016/0149444 A1
(43) Pub. Date: May 26, 2016

(54) STATOR OF INTERIOR PERMANENT MAGNET SYNCHRONOUS MOTOR

(71) Applicants: Hyundai Motor Company, Seoul (KR); Kia Motors Corporation, Seoul (KR)

(72) Inventors: Sanghoon Moon, Yongin (KR); Hyoungjun Cho, Seoul (KR); Yeonho Kim, Suwon (KR); Kyoungbum Kim, Yongin (KR); SangHwa Do, Seongnam (KR); WoongChan Chae, Gwangmyeong (KR); Ki Nam Kim, Seongnam (KR); Jung Shik Kim, Seoul (KR)

(21) Appl. No.: 14/722,269

(22) Filed: May 27, 2015

(30) Foreign Application Priority Data
Nov. 24, 2014 (KR) 10-2014-0164783

(51) Int. Cl. H02K 1/14

(52) U.S. Cl. CPC H02K 1/146

(57) ABSTRACT

A stator of an interior permanent magnet synchronous motor is provided. The stator spaced apart from a rotor by a predetermined gap within an interior permanent magnet synchronous motor includes a stator tooth that is circumferentially spaced apart by a predetermined distance while interposing a slot therebetween that corresponds to an exterior diameter surface of the rotor. Additionally, a stator shoe is formed at an end of the stator tooth and includes an interior diameter surface of a predetermined diameter that faces the exterior diameter surface of the rotor. A cross point between a circle has a diameter of (interior diameter of the stator shoe×1.0287×24/slot number) mm and the stator tooth is a tooth end start point of the stator tooth.

### CROSS-REFERENCE TO RELATED APPLICATION

This application claims priority to and the benefit of Korean Patent Application No. 10-2014-0164783 filed in the Korean Intellectual Property Office on Nov. 24, 2014, the entire contents of which are incorporated herein by reference.

### BACKGROUND

(a) Field of the Invention

The present invention relates to an interior permanent magnet synchronous motor. More particularly, the present invention relates to a stator of an interior permanent magnet synchronous motor that reduces cogging torque.

(b) Description of the Related Art

In general, a hybrid vehicle or an electric vehicle is driven by an electric motor (hereinafter referred to as “drive motor”) to obtain rotating force by electrical energy. The hybrid vehicle travels in an electric vehicle (EV) mode which is a pure electric vehicle mode using power of a drive motor, or travels in a hybrid electric vehicle (HEV) mode using both of torque of an engine and torque of the drive motor as power. Further, a general electric vehicle travels using torque of the drive motor as the power.

The drive motor that operates as a power source of an environmentally friendly vehicle generally uses a permanent magnet synchronous motor (PMSM). The permanent magnet synchronous motor includes a stator, a rotor spaced apart from the stator by a predetermined gap, and a permanent magnet embedded in the rotor. The permanent magnet synchronous motor may be classified into two types including a surface permanent magnet synchronous motor (SPMM) in which a permanent magnet is installed at a surface of a rotor, and an interior permanent magnet synchronous motor (IPMSM) in which a permanent magnet is mounted in the rotor according to a method of installing the permanent magnet in the rotor.

Among the permanent magnet synchronous motors, since a surface synchronous motor has a saliency ratio being an inductance difference between a D-axis and Q-axis of 0 (D-axis inductance is the same a Q-axis inductance), reluctance torque is not generated. However, since the interior synchronous motor generates reluctance torque due to a saliency ratio, the interior synchronous motor is applicable to a drive motor of a hybrid vehicle or an electric vehicle requiring high efficiency and output density.

Meanwhile, the interior permanent magnet synchronous motor as described above is classified into a concentrated winding type of interior permanent magnet synchronous motor and a distributed winding type of interior permanent magnet synchronous motor according to a winding type of a stator coil. Among them, the concentrated winding type of interior permanent magnet synchronous motor is used in an environmentally friendly vehicle, and is applied to a drive motor of the hybrid vehicle. For example, performance of the concentrated winding type of interior permanent magnet synchronous motor may be determined based on a cogging torque.

When the permanent magnet synchronous motor is rotated in a no-load state, a torque value is periodically changed, which is defined as cogging torque. The cogging torque is one of main parameters in the gradual acceleration/speed reduction in the environmentally-friendly vehicle, and is one of main performance parameters in the design of the drive motor of the environmentally friendly vehicle. The cogging torque may be generated due to static magnetic pull of the stator and the rotor based on a position of the rotor. Upon gradual acceleration/speed reduction of the environmentally friendly vehicle, that is, in a condition requiring a low load in the drive motor, an amplitude of whine noise generated from the drive motor may be changed based on the magnitude of the cogging torque.

In general, the concentrated winding type interior permanent magnet synchronous motor generates greater cogging torque than that of the distributed winding type of interior permanent magnet synchronous motor. In the environmentally friendly vehicle using the concentrated winding type of interior permanent magnet synchronous motor as the drive motor in the art, there is a need to design minimization of the cogging torque to reduce noise upon gradual acceleration/speed reduction.

Particularly, cogging torque in the concentrated winding type of interior permanent magnet synchronous motor driven according to three phase power and having a structure of a pole number and slot number of 2 and 3 is generated according to a least common multiple×rotation frequency of the slot number of the stator and the pole number of the rotor. For example, cogging torque (e.g., of about 5.4 Nm) in the concentrated winding type of interior permanent magnet synchronous motor having a stator configured by 16 poles and 24 slots may cause an audible noise sensed or heard by a driver as a 48th component frequency of a mechanical rotation frequency.

The above information disclosed in this section is merely for enhancement of understanding of the background of the invention and therefore it may contain information that does not form the prior art that is already known in this country to a person of ordinary skill in the art.

### SUMMARY

The present invention provides a stator of an interior permanent magnet synchronous motor having advantages of reducing cogging torque while minimizing performance deterioration of a motor by improving a tooth structure and a slot opening length. An exemplary embodiment of the present invention provides a stator spaced apart from a rotor by a predetermined gap within an interior permanent magnet synchronous motor, the stator may include: stator teeth circumferentially spaced apart by a predetermined distance while interposing a slot therebetween that corresponds to an exterior diameter surface of the rotor; and a stator shoe formed at an end of the stator tooth, and including an interior diameter surface of a predetermined diameter facing the exterior diameter surface of the rotor. Additionally, a cross point between a circle having a diameter of (e.g., interior diameter of stator shoe×1.0287×24/slot number) mm and the stator tooth is as a tooth end start point of the stator tooth.

A tooth end angle of a stator tooth with respect to both ends of the stator shoe may be set to the range of about 125.0 to 125.4°. A slot opening length between both ends of the stator shoe and both ends of an adjacent stator shoe may be set (e.g., interior diameter of the stator shoe×0.01685×24/slot number). A lateral side of both ends of the stator tooth may be disposed parallel to a lateral side of an adjacent stator tooth. When the stator is configured by 16 poles and 24 slots, and a diameter of the tooth end start point based on a center of the rotor is to about 207.6 mm, the slot opening length may be about 3.4 mm.

A main use region efficiency of about 94.66% may be satisfied when a main use region efficiency of the motor is set to a reference value of about 94.5% or greater. A maximum output of about 45.13 KW may be satisfied when a maximum output of the motor is set to a reference value of about 44 KW or greater. Further, cogging torque of about 3.79 Nm may be satisfied when cogging torque of the motor is set to a reference value of about 5.38 Nm or less.

### BRIEF DESCRIPTION OF THE DRAWINGS

In the following detailed description, exemplary embodiments of the present invention have been shown and described, simply by way of illustration.

FIG. 1 is an exemplary view illustrating a stator of an interior permanent magnet synchronous motor according to an exemplary embodiment of the present invention;

FIGS. 2A-2B shows exemplary curves illustrating cogging torque analysis results based on the stator of an interior permanent magnet synchronous motor according to an exemplary embodiment of the present invention and a comparative example;

FIGS. 3A-3D show exemplary tables illustrating an operational effect of the stator of an interior permanent magnet synchronous motor according to an exemplary embodiment of the present invention; and

FIGS. 4A-4B show exemplary graphs illustrating noise improvement effects according to the stator of an interior permanent magnet synchronous motor according to an exemplary embodiment of the present invention and a comparative example.

### DESCRIPTION OF SYMBOLS

1 . . . rotor
3 . . . permanent magnet
5 . . . stator coil
11 . . . stator tooth
21 . . . stator shoe
31 . . . slot
41 . . . slot opening part
51 . . . circle
53 . . . tooth end start point

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

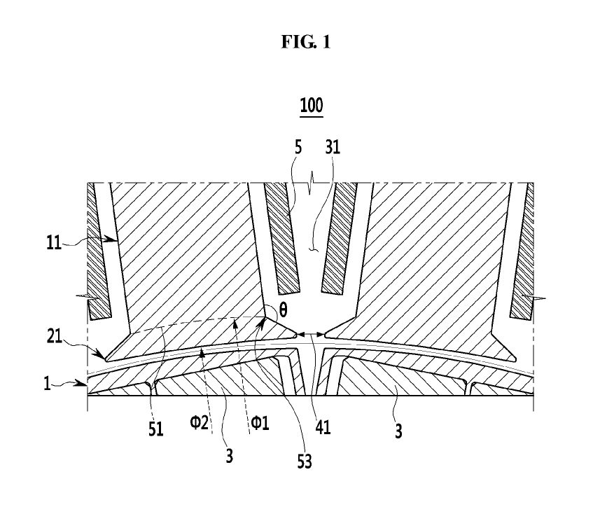

FIG. 1 is an exemplary view illustrating a stator of an interior permanent magnet synchronous motor according to an exemplary embodiment of the present invention. Referring to FIG. 1, a stator 100 according to an exemplary embodiment of the present invention is applied to an interior permanent magnet synchronous motor (IPMSM) where a permanent magnet may be embedded wherein a stator.

The interior permanent magnet synchronous motor may be applicable to a drive motor of an environmentally friendly vehicle such as a hybrid vehicle to generate driving torque by electrical energy. Further, the stator 100 according to an exemplary embodiment of the present invention may be applicable to a concentrated winding type of interior permanent magnet synchronous motor. For example, the interior permanent magnet synchronous motor may be an inner rotor type of synchronous motor, and may include a stator 100, a rotor 1 rotatably installed at an inner side of the stator 100 to be spaced apart from the stator 100 by a predetermined gap, and a plurality of permanent magnets 3 embedded within the rotor 1 according to an exemplary embodiment of the present invention.

In particular, the stator 100 of the interior permanent magnet synchronous motor according to an exemplary embodiment of the present invention may include a stator core in which a plurality of steel plates are laminated, and a stator core of the stator 100 may include stator teeth 11 and stator shoes 21. The stator teeth 11 may be wound by a stator coil 5 and may be circumferentially spaced apart by a predetermined distance while interposing a slot 31 therebetween that corresponds to an exterior diameter surface of the rotor 1.

The stator shoe 21 may be formed at an end of the stator tooth 11, and may form an interior diameter surface having a predetermined diameter facing an exterior diameter surface of the rotor 1. Additionally, ends of the stator shoes 21 may protrude toward the ends of adjacent stator shoes 21. In other words, each stator shoe 21 may be formed with both sides thereof (right and left sides in the drawing) formed symmetrically based on a center of the stator tooth 11, that is, a connected center line based on a rotation center point of the rotor 1. Particularly, as described above, since both ends of the stator shoe 21 may protrude toward both ends of adjacent stator shoes 21, in an exemplary embodiment of the present invention, the adjacent stator shoes 21 may form a narrow gap that is sufficient to wind the stator coil 5 around the stator tooth 11. Hereinafter, a gap between both ends of the adjacent stator shoes 21 refers to a slot opening part 41.

In accordance with an exemplary embodiment of the present invention, as described above, the stator 100 of the interior permanent magnet synchronous motor may have a structure that may reduce cogging torque while minimizing performance deterioration of a motor by improving a structure of a stator tooth 11 and a length of a slot opening part 41.

Accordingly, the stator 100 of the interior permanent magnet synchronous motor may set a cross point between a circle 51 having a diameter φ1 of (interior diameter φ2 of stator shoe×1.0287×24/slot number) mm and the stator tooth as a tooth end start point 53 of the stator tooth 11. In particular, the diameter φ1 based on a center of the rotor 1 may be defined as a diameter of the tooth end start point 53. Further, a constant of 1.0287 may be a value obtained from a design process of the stator 100 and the rotor 1.

Hereinafter, the stator 100 according to an exemplary embodiment of the present invention may have a configuration of 16 poles and 24 slots, which will be described as prerequisites for setting a diameter of the tooth end start point 53 based on a center of the rotor 1 to about 207.6 mm. Accordingly, as the diameter of the tooth end start point 53 is set to about 207.6 mm, an interior diameter φ2 of the stator shoe 21 may be about 201.80 mm in consideration of a diameter φ1 based on a center of the rotor 1 being (interior diameter φ2 of rotor shoe×1.0287×24/slot number) mm. In other words, the center of the rotor 1 may be defined by the following equation:

(interior diameter φ2 of rotor shoe×1.0287×24/slot number) mm

Further, in an exemplary embodiment of the present invention, a tooth end angle θ of a stator tooth 11 with respect to both ends of the stator shoe 21 may be set to the range of about 125.0 to 125.4° and the above length of the slot opening part 41 may be set to (interior diameter of stator shoe×0.01685×24/slot number) mm. In particular, a constant of 0.01685 may be a constant value obtained from a design process of the stator 100 and the rotor 1. Accordingly, in an exemplary embodiment of the present invention, a slot opening length of a slot opening part 41 being a gap between both ends of the stator shoe 21 and both ends of an adjacent stator shoe 21 may satisfy about 3.4 mm.

Further, a lateral side of both ends of the stator tooth 11 may be disposed parallel to a lateral side of an adjacent stator tooth 11. Accordingly, in accordance with the stator 100 of the interior permanent magnet synchronous motor constructed as described above, based on the assumption that a diameter of the tooth end start point 53 of the stator tooth 11 as a configuration of 16 poles and 24 slots is set to about 207.6 mm, a slot opening length between both ends of the stator shoe 21 may be set to about 3.4 mm, and a tooth end angle θ of the stator tooth 11 may be set to the range of about 125.0 to 125.4°.

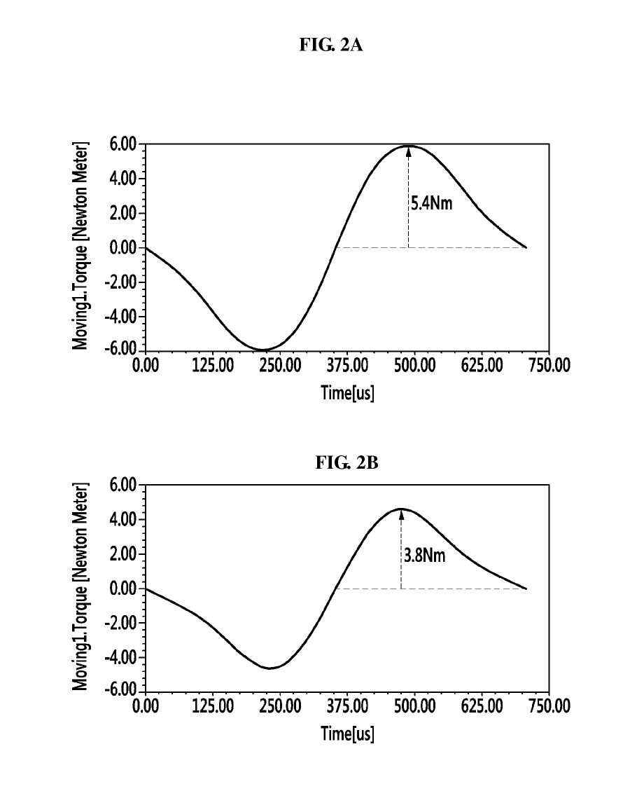

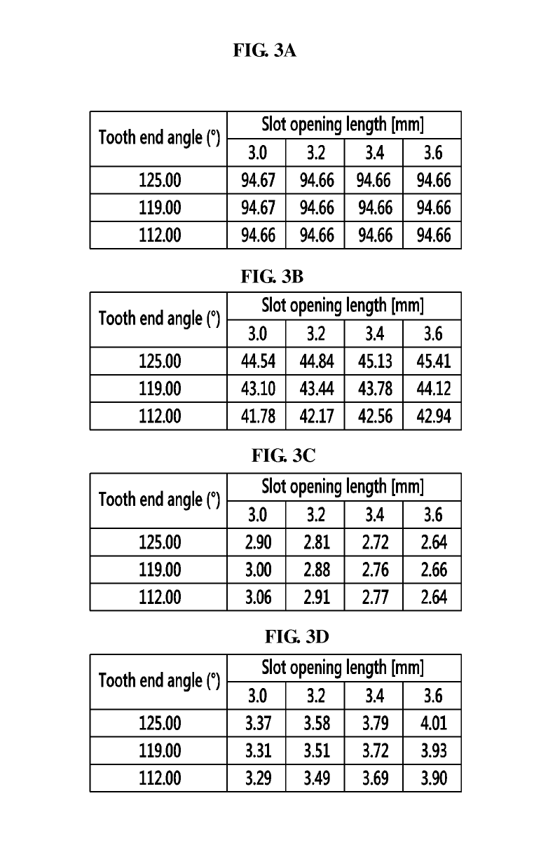

Accordingly, in an exemplary embodiment of the present invention, in the above assumption conditions, by limiting the slot opening length of the stator shoe 21 and a tooth end angle of the stator tooth 11 to a particular number, magnetic pull of the stator 100 and the rotor 1 may be controlled to improve cogging torque by about 30% or greater as shown in FIG. 2B as compared with no load cogging torque of a general drive motor according to the comparative example shown in FIG. 2A. In particular, in an exemplary embodiment of the present invention, the performance of a motor and a reduction effect of cogging torque according to the above limitation of the number are listed in FIGS. 3A-3D.

In an exemplary embodiment of the present invention, due to the predetermined structure of the stator 100 as described above, when main use region efficiency of the motor as shown in FIG. 3A is set to a reference value of about 94.5% or greater, the stator 100 may represent a main use region efficiency of about 94.66%.

Moreover, in an exemplary embodiment of the present invention, as shown in FIG. 3B, when a maximum output of the motor is set to a reference value of about 44 KW or greater, the motor may represent the maximum output of about 45.13 KW. In addition, in an exemplary embodiment of the present invention, as illustrated in FIG. 3C, when a torque ripple of the motor is set to a reference value of about 2.8% or less, a torque ripple of about 2.72% is represented. As illustrated in FIG. 3D, when cogging torque of the motor is set to a reference value of about 5.38 Nm or less, cogging torque of about 3.79 Nm may be represented.

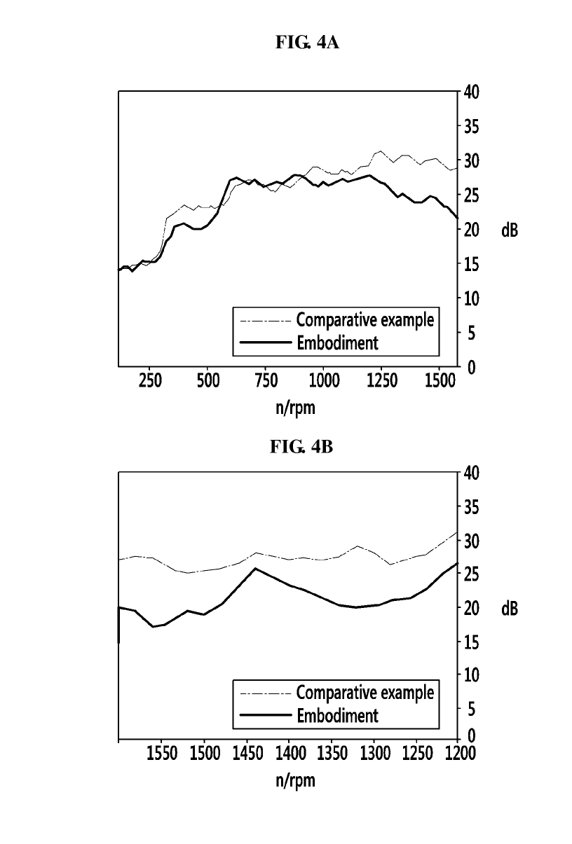

Accordingly, in accordance with an exemplary embodiment of the present invention, since the cogging torque may be reduced while maintaining the performance and efficiency of the motor by improving a structure of the stator tooth 11 and a length of the slot opening part 41, upon gradual acceleration level 1 of the vehicle as illustrated in FIG. 4A and reduction speed of the vehicle as illustrated in FIG. 4B, the noise caused by the cogging torque may be improved by about 5 dB compared to the comparative example.

While this invention has been described in connection with what is presently considered to be exemplary embodiments, it is to be understood that the invention is not limited to the disclosed exemplary embodiments. On the contrary, it is intended to cover various modifications and equivalent arrangements included within the spirit and scope of the appended claims.

What is claimed is:

1. A stator spaced apart from a rotor by a predetermined gap within an interior permanent magnet synchronous motor, the stator comprising:
stator teeth circumferentially spaced apart by a predetermined distance while interposing a slot therebetween that corresponds to an exterior diameter surface of the rotor; and
a stator shoe formed at an end of the stator tooth, and having an interior diameter surface of a predetermined diameter facing the exterior diameter surface of the rotor,
wherein a cross point between a circle having a diameter of (interior diameter of the stator shoe×1.0287×24/slot number) mm and the stator tooth is a tooth end start point of the stator tooth.

2. The stator of an interior permanent magnet synchronous motor of claim 1, wherein a tooth end angle of a stator tooth with respect to both ends of the stator shoe is set to the range of about 125.0 to 125.4°.

3. The stator of an interior permanent magnet synchronous motor of claim 2, wherein a slot opening length between both ends of the stator shoe and both ends of an adjacent stator shoe is set to (interior diameter of the stator shoe×0.01685×24/slot number) mm.

4. The stator of an interior permanent magnet synchronous motor of claim 1, wherein a lateral side of both ends of the stator tooth is disposed in parallel with a lateral side of an adjacent stator tooth.

5. The stator of an interior permanent magnet synchronous motor of claim 3, wherein when the stator includes 16 poles and 24 slots, and a diameter of the tooth end start point based on a center of the rotor is about 207.6 mm, and the slot opening length satisfies about 3.4 mm.

6. The stator of an interior permanent magnet synchronous motor of claim 5, wherein a main use region efficiency of about 94.66% is satisfied when a main use region efficiency of the motor is set to a reference value of about 94.5% or greater, and a maximum output of about 45.13 KW is satisfied when a maximum output of the motor is set to a reference value of about 44 KW or greater.

7. The stator of an interior permanent magnet synchronous motor of claim 6, wherein cogging torque of about 3.79 Nm is satisfied when cogging torque of the motor is set to a reference value of about 5.38 Nm or less.
